(19) United States
(12) Patent Application Publication
(10) Pub. No.: US 2018/0072023 A1
(43) Pub. Date: Mar. 15, 2018

(54) Multiple-Layer Flexible Film And The Method Of Making The Same

(71) Applicant: ACPO, Ltd., Oak Harbor, OH (US)

(72) Inventors: Dennis M. Liebman, Oak Harbor, OH (US); Dean T. Dupont, Oak Harbor, OH (US)

(21) Appl. No.: 15/698,832

(22) Filed: Sep. 8, 2017

Related U.S. Application Data
(60) Provisional application No. 62/385,684, filed on Sep. 9, 2016.

(51) Int. Cl. B32B 27/08; B65H 75/08; B65D 65/40

(52) U.S. Cl. CPC B32B 27/08; B65H 75/08; B65H 2701/1752; B32B 2307/7244; B32B 2439/70; B65D 65/40

(57) ABSTRACT

A multi-layer flexible film includes a first polymeric layer. A functional layer is disposed over a first major surface of the first polymeric layer. A barrier layer is disposed over a second major surface of the first polymeric layer. The first polymeric layer separates the barrier layer from the functional layer. An adhesive layer is disposed over the barrier layer. The adhesive layer defines a first outer surface of the multi-layer flexible film.

### CROSS-REFERENCE TO RELATED APPLICATION

This application is claiming the benefit, under 35 U.S.C. 119(e), of the provisional U.S. patent application which was granted Ser. No. 62/385,684 and filed on Sep. 9, 2016, the entire disclosure of which is hereby incorporated by reference.

### BACKGROUND OF THE INVENTION

The invention relates to a multiple-layer flexible film. More particularly, the invention relates to a multiple-layer flexible film for use in packaging. Also, the invention relates to a method of making the multiple-layer flexible film.

Flexible packaging structures are known to be utilized in food packaging. Such structures are often formed by converting multi-layer flexible films. Such films often include a barrier layer that resists transmission of oxygen and other gases into the structure. Barrier layers known in the art can be easily damaged when forming the packaging structure. Furthermore, the multi-layer films known in the art require complex processes and tooling to be converted.

It would be advantageous to provide a multiple-layer flexible film that protects the barrier layer from damage and that could be more easily converted. A method of making such a film would also be advantageous.

### BRIEF SUMMARY OF THE INVENTION

Embodiments of a multi-layer flexible film are provided.

In an embodiment, the multi-layer flexible film comprises a first polymeric layer. A functional layer is disposed over a first major surface of the first polymeric layer. A barrier layer is disposed over a second major surface of the first polymeric layer. The first polymeric layer separates the barrier layer from the functional layer. An adhesive layer is disposed over the barrier layer. The adhesive layer defines a first outer surface of the multi-layer flexible film.

In another embodiment, the multi-layer flexible film comprises a first polymeric layer. The first polymeric layer comprises a polyolefin. A functional layer is disposed directly a first major surface of the first polymeric layer. A barrier layer is disposed directly on a second major surface of the first polymeric layer. The barrier layer comprises a polymer and is separated from the functional layer by the first polymeric layer. An adhesive layer is disposed directly on the barrier layer. The adhesive layer comprises a pressure sensitive adhesive and defines a first outer surface of the multi-layer flexible film.

### BRIEF DESCRIPTION OF THE SEVERAL VIEWS OF THE DRAWING

The above, as well as other advantages of the embodiments will become readily apparent to those skilled in the art from the following detailed description when considered in the light of the accompanying drawings in which:

FIG. 1 depicts a sectional view of an embodiment of a multiple-layer flexible film in accordance with the invention; and

FIG. 2 depicts a sectional view of a roll of the multiple-layer flexible film of FIG. 1.

### DETAILED DESCRIPTION OF THE INVENTION

It is to be understood that the invention may assume various alternative orientations and step sequences, except where expressly specified to the contrary. It is also to be understood that the specific layers, films, methods and processes illustrated in the attached drawing, and described in the following specification are simply exemplary embodiments of the inventive concepts. Hence, specific dimensions, directions, or other physical characteristics relating to the embodiments disclosed are not to be considered as limiting, unless expressly stated otherwise.

Embodiments of a multiple-layer flexible film 10 in accordance with the invention will be described below. The embodiments of the multiple-layer flexible film 10 may be utilized with one or more additional layers. For example, an additional exterior layer and a layer of a sealing material may be applied to the multiple-layer flexible film 10. Also, the embodiments of the multiple-layer flexible film 10 may be utilized to form a flexible packaging structure such as, for example, a bag, sack, pouch, or overwrap. The flexible packaging structure may then be utilized to package food items. However, it should be appreciated that the multiple-layer flexible film 10 may be converted into other structures and have medical, industrial, retail, or other specialized applications.

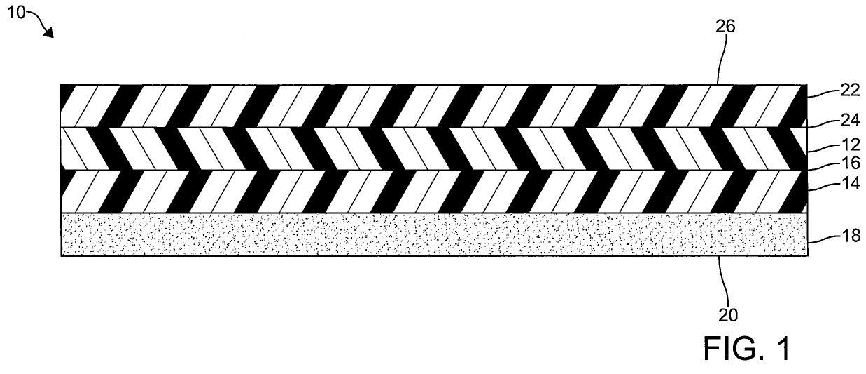

FIG. 1 illustrates certain embodiments of the multiple-layer flexible film 10. In certain embodiments, the multiple-layer flexible film 10 may be transparent. In other embodiments, the multiple-layer flexible film 10 may be opaque. In these embodiments, the multiple-layer flexible film may be printed on. Also, the thickness of the multiple-layer flexible film 10 may vary between the invention embodiments.

The multiple-layer flexible film 10 comprises a first polymeric layer 12. The first polymeric layer 12 can be formed by extrusion, casting, or another process.

The thickness of the first polymeric layer 12 may vary between embodiments of the multiple-layer flexible film 10.

Preferably, the first polymeric layer 12 comprises a polyolefin. In these embodiments, the polyolefin may be polyethylene, polypropylene, polyester or another suitable polyolefin. In one such embodiment, the first polymeric layer 12 may be a blend of polyolefins. In another embodiment, the first polymeric layer 12 may comprise coextruded polyolefins. In other embodiments, the first polymeric layer 12 may comprise another suitable polymeric material.

A barrier layer 14 is disposed over and, preferably, directly on a first major surface 16 of the first polymeric layer 12. The barrier layer 14 may be disposed over the first polymeric layer 12 by any suitable method. For example, the barrier layer 14 may be extruded, laminated, or deposited onto the first polymeric layer 12. Other methods are suitable for applying the barrier layer 14 over the first polymeric layer 12. It should be appreciated that in the embodiments where the barrier layer 14 is disposed directly on the first major surface 16 of the first polymeric layer 12 there are no intervening layers that separate the barrier layer 14 and the first polymeric layer 12.

The barrier layer 14 is provided in the flexible film 10 to help prevent diffusion and transmission of oxygen and other gases into the packaging structure. The barrier layer 14 may also help prevent the transmission of moisture into the packaging structure. Thus, the barrier layer 14 provides a barrier that resists the diffusion of gases and moisture through the flexible film 10 and from one side of the barrier layer 14 to the other. In these embodiments, the barrier layer 14 may be chlorine free.

In certain embodiments, like the one illustrated in FIG. 1, the barrier layer 14 may comprise one or more polymer materials. Suitable polymers for use in the barrier layer 14 include ethylene vinyl alcohol, polyvinyl alcohol, polyamide, polychlorotrifluoroethylene, and polyesters such as poly(ethylene terephthalate). In other embodiments, the barrier layer 14 may comprise a polymer matrix formed from one or more of the polymers listed above. In these embodiments, the polymer matrix may include an inorganic material. Inorganic materials that are preferred resist the diffusion of oxygen and moisture. In one such embodiment, the inorganic material comprises a silicate. The silicate contained in the polymer matrix may be naturally occurring or synthetically formed. As an example, naturally occurring silicates include natural clays. In still other embodiments (not depicted), the barrier layer may be metalized. For example, the barrier layer may comprise aluminum, another suitable metal, or a metal oxide such as, for example, aluminum oxide or a similar metal oxide. In another embodiment, the barrier layer may be a metallized polymer. For example, the barrier layer may comprise a polyester layer coated with a thin layer of metal or a metal oxide. In this embodiment, the barrier layer may comprise a poly(ethylene terephthalate) layer and a layer of aluminum.

An adhesive layer 18 is disposed over and, preferably, directly on the barrier layer 14. In this position, the adhesive layer 18 is separated from the first polymeric layer 12 by the barrier layer 14. Also, it should be appreciated that when the adhesive layer 18 is disposed directly on the barrier layer 14 there are no intervening layers that separate the adhesive layer 18 and the barrier layer 14. Preferably, the adhesive layer 18 is an outermost layer of the multiple-layer flexible film 10 and defines a first outer surface 20 thereof. In this orientation, the adhesive layer 18 protects the barrier layer 14 from damage and degradation that occurs when the flexible film is converted into a flexible packaging structure (not depicted). Also, prior to forming the packaging structure, the adhesive layer 18 may be utilized to secure a second polymeric layer (not depicted) to the multiple-layer flexible film 10 in a secondary process.

The adhesive layer 18 comprises an adhesive. It has been discovered that when certain adhesives are disposed over the barrier layer 14, certain barrier properties, e.g. resistance to the transmission of oxygen, other gases, and moisture, of the barrier layer 14 may decline. However, the inventors have discovered that with the selection of a suitable adhesive these barrier properties of the barrier layer 14 can be maintained. Preferably, the adhesive selected for the adhesive layer 18 is of the pressure sensitive variety. Suitable adhesives for use in the adhesive layer 18 include acrylics, natural rubbers, synthetic rubbers and other pressure sensitive adhesives.

Additionally, the adhesive layer 18 may comprise a cure mechanism. Preferably, the cure mechanism allows the adhesive layer 18 to be cured in a short period of time. In an embodiment, the adhesive layer 18 comprises a thermal cure mechanism. In another embodiment, the adhesive layer 18 comprises a light cure mechanism. In this embodiment, the adhesive includes a material which absorbs light to initiate curing of the adhesive layer 18. Preferably, when the adhesive layer 18 comprises a light cure mechanism, the adhesive is cured by exposure to UV light. In other embodiments, the cure mechanism may be one of an ambient moisture cure or a reactive system cure. In still other embodiments, the adhesive layer 18 may comprise a secondary cure mechanism.

The multiple-layer flexible film 10 also comprises a functional layer 22. In certain embodiments, the multiple-layer flexible film 10 consists of the aforementioned layers 12, 14, 18, 22. The functional layer 22 is disposed over and, preferably, directly on a second major surface 24 of the first polymeric layer 12. In this position, the functional layer 22 is separated from the adhesive layer 18 by the first polymeric layer 12 and the barrier layer 14. It should be appreciated that when the functional layer 22 is disposed directly on the second major surface 24 of the first polymeric layer 12 there are no intervening layers that separate the functional layer 22 and the first polymeric layer 12. The functional layer 22 may be disposed over the first polymeric layer 12 by any suitable method. For example, the functional layer 22 may be extruded, laminated, or deposited onto the first polymeric layer 12. Other methods may be suitable for disposing the functional layer over the first polymeric layer.

Preferably, the functional layer 22 is an outermost layer of the multiple-layer flexible film 10 and defines a second outer surface 26 thereof. Preferably, the first outer surface 20 and the second outer surface 26 are oriented in a parallel relationship with each other. The functional layer 22 modifies one or more properties or characteristics of the multiple-layer flexible film 10. For example, the functional layer 22 can provide a release mechanism. In the embodiments described herein, a release mechanism is beneficial when the multi-layer flexible film 10 is provided as a roll and is being unwound. When the multiple-layer flexible film 10 includes a release mechanism, it is preferred that the functional layer 22 comprises a polyurethane and silicone, wax or another suitable release agent. In another embodiment, the functional layer 22 may be provided to increase or decrease the tactile properties of the multiple-layer flexible film 10. In still another embodiment, the functional layer 22 may be provided to modify the surface properties of the multiple-layer flexible film 10 so that the printability of the second outer surface 26 of the multiple-layer flexible film 10 is increased. It is preferred that when the functional layer 22 is printable, then it is not utilized to seal the flexible packaging structure after the multiple-layer flexible film 10 has been converted into such a structure. For example, in this embodiment, the functional layer 22 is not heat sealable. Also, it should be appreciated that for this embodiment, the functional layer 22 may be printed on. In other embodiments, the functional layer 22 may be utilized to seal the flexible packaging structure after the multiple-layer flexible film 10 has been converted into such a structure. In one such embodiment, the functional layer 22 may be heat sealable and comprise a heat sealable material. When the functional layer 22 is heat sealable, the functional layer 22 is not printed on. Thus, in this embodiment, the functional layer 22 may comprise one or more materials which render the functional layer 22 not printable. Also, when the functional layer 22 is heat sealable, an additional sealing layer (not depicted) such as, for example, another adhesive layer is advantageously not required. Thus, in this embodiment, an additional adhesive layer is not disposed over the functional layer 22. In still further embodiments, the functional layer 22 provides the release mechanism, increases the tactile properties of the multiple-layer flexible film 10, and modifies the surface properties of the multiple-layer flexible film 10 to increase the printability of the second outer surface 26 of the multiple-layer flexible film 10.

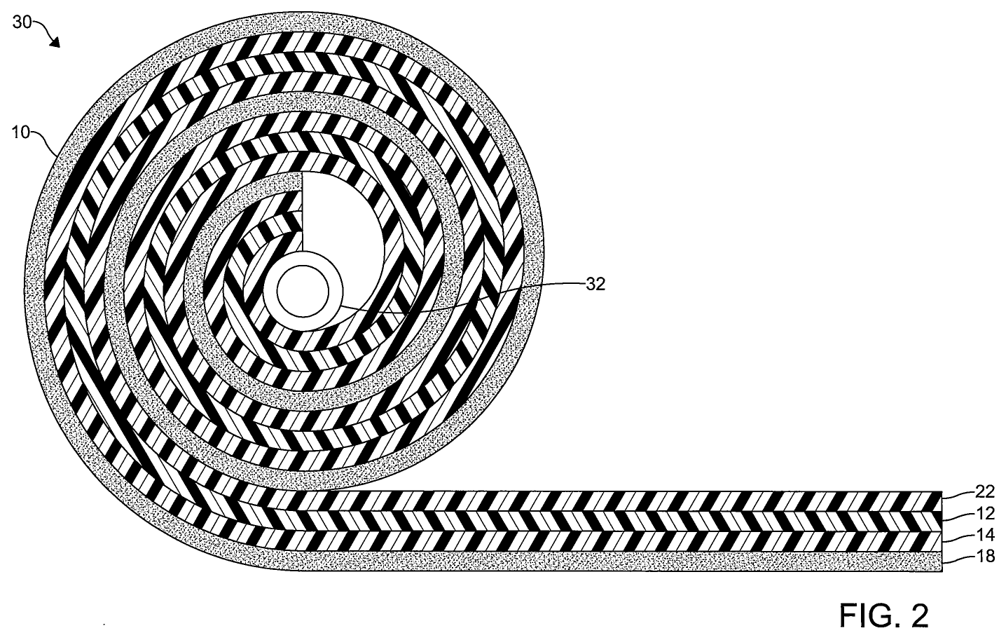

After the multiple-layer flexible film 10 is formed it may be wound into a roll 30. An embodiment of a roll 30 of the multiple-layer flexible film 10 is illustrated in FIG. 2. In order to form the roll 30, the flexible film 10 may be cut to a desired length. The length of the multiple-layer flexible film 10 provided in the roll 30 can be predetermined. The roll may further comprise a spool 32. When provided, the multiple-layer flexible film 10 may be disposed around the spool via winding or a similar process. More particularly, in an embodiment like the one illustrated in FIG. 2, when the multiple-layer flexible film 10 is provided in the roll 30, a portion of the functional layer 22 is disposed over the spool 32. Preferably, in this embodiment, another portion of the functional layer 22 is disposed over and, preferably, directly on the adhesive layer 18.

Preferably, the roll 30 is utilized in a secondary process. In the secondary process, the roll 30 may be unwound and the second polymeric layer secured to the multiple-layer flexible film 10 via the adhesive layer 18. In embodiments where the functional layer 22 is heat sealable, it may be preferred that the second polymeric layer can be printed on. In these embodiments, it is preferred that the second polymeric layer comprises the same polymeric material as the first polymeric layer 12. In other embodiments, the second polymeric layer may be utilized to seal the flexible packaging structure after the multiple-layer flexible film 10 has been converted into such a structure. In these embodiments, the second polymeric layer may be heat sealable. In still other embodiments, after the second polymeric layer is secured to the multiple-layer flexible film 10, a sealing material (not depicted) may be applied over one or both of the functional layer 22 and the second polymeric layer. In these embodiments, the sealing material is utilized to seal the flexible packaging structure. A preferred sealing material for use in the flexible packaging structure is low density polyethylene.

The foregoing description is considered as illustrative only of the principles of the invention. Further, since numerous modifications and changes will readily occur to those skilled in the art, it is not desired to limit the invention to the exact construction and processes shown and described herein. Accordingly, all suitable modifications and equivalents may be considered as falling within the scope of the invention.

1. A multi-layer flexible film, comprising:
a first polymeric layer;
a functional layer disposed over a first major surface of the first polymeric layer;
a barrier layer disposed over a second major surface of the first polymeric layer, the first polymeric layer separating the barrier layer from the functional layer; and
an adhesive layer disposed over the barrier layer, the adhesive layer defining a first outer surface of the multi-layer flexible film.

2. The multi-layer flexible film of claim 1, wherein the first polymeric layer comprises a polyolefin.

3. The multi-layer flexible film of claim 1, wherein the functional layer defines a second outer surface of the multiple layer flexible film.

4. The multi-layer flexible film of claim 1, wherein the barrier layer comprises a polymer, a metal, or a metalized polymer.

5. The multi-layer flexible film of claim 1, wherein the barrier layer is chlorine free.

6. The multi-layer flexible film of claim 1, wherein the barrier layer comprises a polymer matrix and silicate.

7. The multi-layer flexible film of claim 1, wherein the functional layer is disposed directly on the first major surface of the first polymeric layer and the barrier layer is disposed directly on the second major surface of the first polymeric layer.

8. The multi-layer flexible film of claim 1, wherein the adhesive layer comprises a pressure sensitive adhesive.

9. The multi-layer flexible film of claim 1, wherein the multi-layer flexible film consists of the first polymeric layer, the functional layer, the barrier layer, and the adhesive layer.

10. The multi-layer flexible film of claim 7, wherein the adhesive layer is disposed directly on the barrier layer.

11. A multi-layer flexible film, comprising:
a first polymeric layer, wherein the first polymeric layer comprises a polyolefin;
a functional layer disposed directly a first major surface of the first polymeric layer;
a barrier layer disposed directly on a second major surface of the first polymeric layer, wherein the barrier layer comprises a polymer and is separated from the functional layer by the first polymeric layer; and
an adhesive layer disposed directly on the barrier layer, the adhesive layer comprising a pressure sensitive adhesive and defining a first outer surface of the multi-layer flexible film.

12. The multi-layer flexible film of claim 11, wherein the functional layer defines a second outer surface of the multiple layer flexible film, the first outer surface and the second outer surface being oriented in a parallel relationship with each other.

13. The multi-layer flexible film of claim 11, wherein the polyolefin is a polyethylene, polypropylene, or polyester.

14. The multi-layer flexible film of claim 12, wherein the functional layer is printable or heat sealable such that if the functional layer is printable, then it is not heat sealable or if the functional layer is heat sealable, then it is not printable.

15. A roll comprising a multi-layer flexible film according to claim 1.

16. The roll of claim 15, further comprising a spool, wherein the multi-layer flexible film is disposed around the spool.

17. The roll of claim 16, wherein a portion of the function layer is disposed over the spool and another portion of the functional layer is disposed over the adhesive layer.
